(19) United States
(12) Patent Application Publication
(10) Pub. No.: US 2017/0195480 A1
(43) Pub. Date: Jul. 6, 2017

(54) VOICE QUALITY DASHBOARD FOR UNIFIED COMMUNICATION SYSTEM

(71) Applicant: Unify Square, Inc., Bellevue, WA (US)

(72) Inventors: Edward Melomed, Bellevue, WA (US); Ameya Sirpotdar, Seattle, WA (US); Christopher O'Brien, Seattle, WA (US); Robert Osborne, Redmond, WA (US); Arun Raghavan, Seattle, WA (US)

(73) Assignee: Unify Square, Inc., Bellevue, WA (US)

(21) Appl. No.: 15/374,654

(22) Filed: Dec. 9, 2016

Related U.S. Application Data
(60) Provisional application No. 62/265,328, filed on Dec. 9, 2015.

(51) Int. Cl. H04M 3/22; H04W 24/02; H04L 12/24

(52) U.S. Cl. CPC H04M 3/2236; H04M 3/2218; H04L 41/22; H04W 24/02; H04L 41/0859

(57) ABSTRACT

A computing device receives an indication of a selected category of items relating to call quality for a plurality of voice calls, such as sites, wireless network identifiers, driver software versions, client software versions, protocols (e.g., virtual private network (VPN), Transmission Control Protocol (TCP), and User Datagram Protocol (UDP)), connectivity methods, and edge servers used in the calls. The computing device selects items in the selected category based on volume of calls. The computing device calculates percentages of poor calls associated with the items, and identifies high-volume poor call items. The computing device also may calculate impact ranks for categories of items, e.g., based on distribution of poor calls, with a lower rank being assigned if poor calls are evenly distributed, and a higher rank being assigned if a small number of items contribute disproportionately to the volume of poor calls.

### CROSS-REFERENCE TO RELATED APPLICATION

This application claims the benefit of U.S. Provisional Application No. 62/265,328, filed Dec. 9, 2015.

### BACKGROUND

Unified communication (UC) services include communication services (e.g., e-mail services, instant messaging services, voice communication services, video conference services, and the like) and UC data management and analysis services. UC platforms allow users to communicate over internal networks (e.g., corporate networks) and external networks (e.g., the Internet). This opens communication capabilities not only to users available at their desks, but also to users who are on the road and even to users from different organizations. With such solutions, end users are freed from limitations of previous forms of communication, which can result in quicker and more efficient business processes and decision making.

However, the quality of communications in such platforms can be affected by a variety of problems, including software failures, hardware failures, configuration problems (e.g., system-wide or within components, such as firewalls and load balancers), and network performance problems. The potential impacts of these and other problems include immediate impact upon end users (both internal and roaming) as well as inefficient use of resources.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, a computing device receives an indication of a selected category of items relating to call quality for a plurality of voice calls. (The category may be selected by a user or administrator, e.g., via a voice quality dashboard, or automatically.) The category is selected from a group including sites, wireless network identifiers (e.g., basic service set IDs (BSSIDs)), driver software versions (e.g., WiFi drivers), client software versions, protocols (e.g., virtual private network (VPN), Transmission Control Protocol (TCP), User Datagram Protocol (UDP)), connectivity methods (e.g., direct, relay, HTTP), and edge servers used in the calls. The computing device selects a plurality of items in the selected category based on volumes of calls associated with the plurality of items. For example, the computing device may select a top 50 of sites or other items by call volume. The computing device calculates percentages of poor calls associated with the plurality of items, and identifies high-volume poor call items based at least in part on whether the items exceed a threshold percentage (e.g., 2% or some other percentage) of poor calls. The computing device causes the high-volume poor call items to be displayed, either at the computing device that performs the process (e.g., in a voice quality dashboard), or at some other location.

In addition to sorting categories of items in this way and identifying high-volume poor call items, the computing device also may calculate impact ranks for categories of items. For example, the impact rank may be based at least in part on distribution of poor calls among the selected category of items, with a lower rank being assigned if poor calls are generally evenly distributed, and a higher rank being assigned if particular items appear to be contributing disproportionately to the volume of poor calls. The computing device causes the impact rank to be displayed, either at the computing device that performs the process (e.g., in a voice quality dashboard), or at some other location.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram that illustrates a generalized UC management and analysis system in which aspects of the present disclosure may be implemented;

FIG. 2 is a block diagram that illustrates another example of a UC management and analysis system in which aspects of the present disclosure may be implemented;

FIG. 3 is a flowchart of an illustrative process for automatically identifying high-volume poor call items in selected categories of items relating to call quality, and calculating impact ranks for selected categories of items;

FIG. 4 is a screen shot of a user interface for displaying poor call information, including impact ranks and selected high-volume poor call items, in a voice quality dashboard of a voice quality monitoring system, according to embodiments described herein; and

FIG. 5 is a block diagram that illustrates aspects of an illustrative computing device appropriate for use in accordance with embodiments of the present disclosure.

### DETAILED DESCRIPTION

The detailed description set forth below in connection with the appended drawings where like numerals reference like elements is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

In the following description, numerous specific details are set forth in order to provide a thorough understanding of illustrative embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein.

### I. Unified Communication System Overview

The present disclosure includes descriptions of various aspects of unified communication (UC) systems, such as UC management and analysis systems, and related tools and techniques. In general, UC systems (including UC systems based on Skype® For Business or Lync® platforms available from Microsoft Corporation, or other UC systems) provide UC services. UC services may include communication services (e.g., e-mail services, instant messaging services, voice communication services, video conference services, and the like) and UC data management and analysis services, or other services.

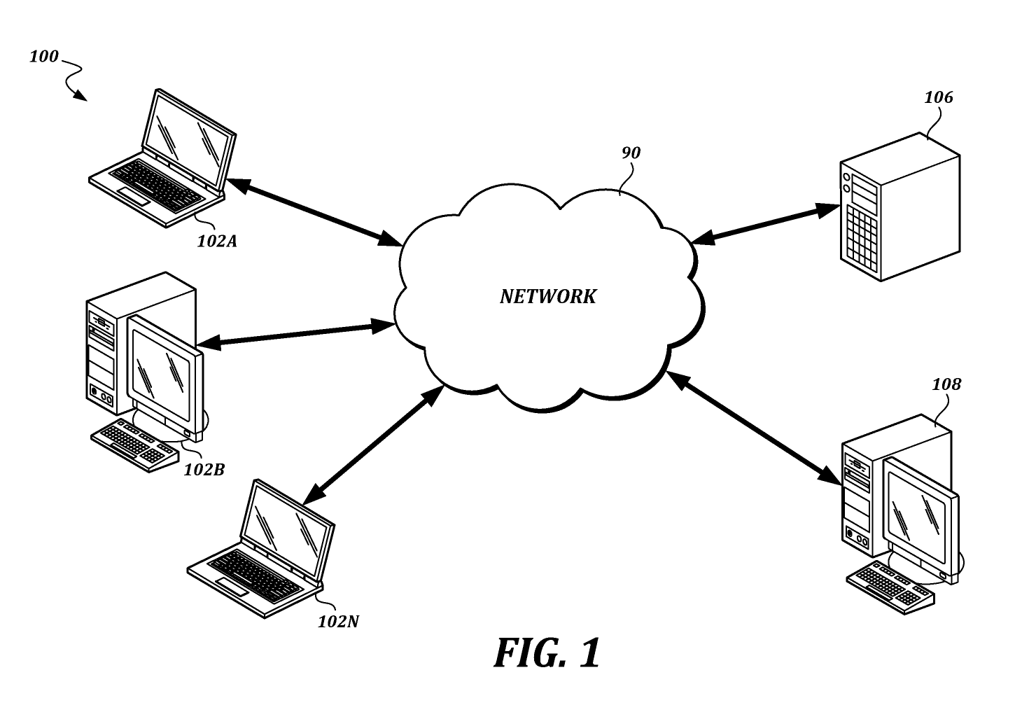

FIG. 1 is a block diagram that illustrates a generalized UC management and analysis system 100 according to various aspects of the present disclosure. In this generalized example, the system 100 includes client computing devices 102A-N, a server computing device 106, and an administrator computing device 108. The components of the system 100 may communicate with each other via a network 90. For example, the network 90 may comprise a wide-area network such as the Internet. The network 90 may comprise one or more sub-networks (not shown). For example, the network 90 may include one or more local area networks (e.g., wired or wireless local area networks) that may, in turn, provide access to a wide-area network such as the Internet. The client computing devices 102A-N may be computing devices operated by end users of a UC system. A user operating the administrator computing device 108 may connect to the server computing device 106 to, for example, manage and analyze use of the UC system.

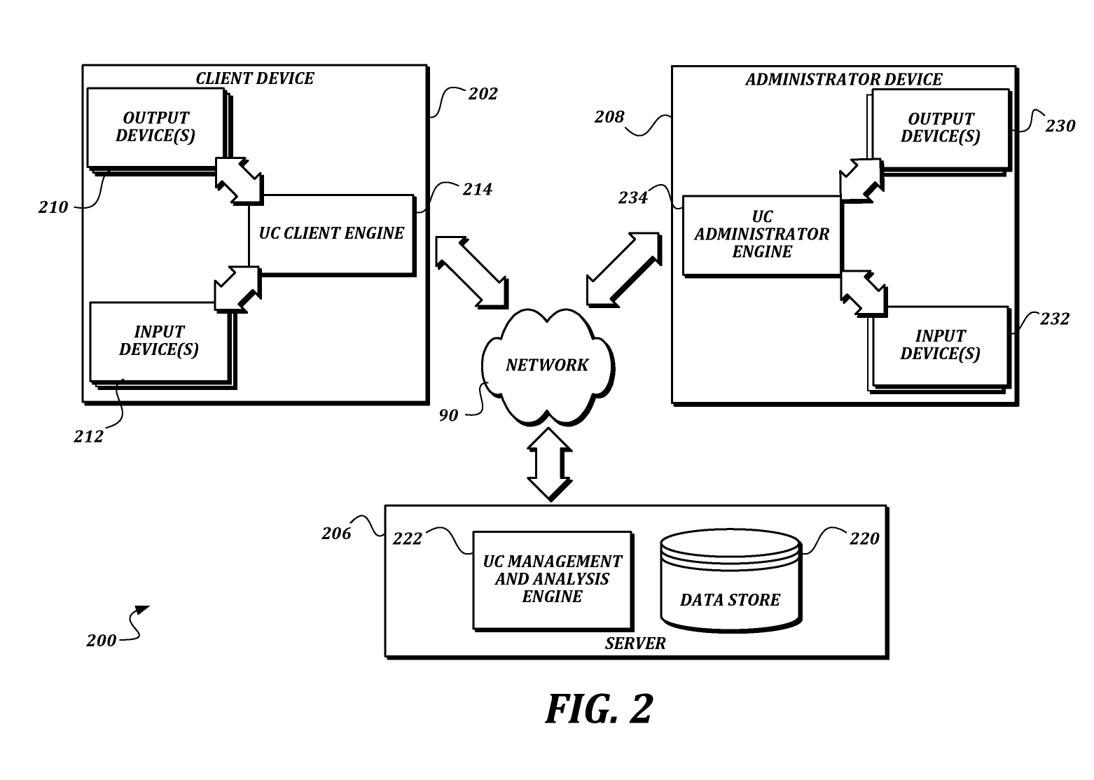

FIG. 2 is a block diagram that illustrates another example of a UC management and analysis system. As shown in FIG. 2, the system 200 comprises a client computing device 202, a server 206, and an administrator computing device 208. In the example shown in FIG. 2, the server computing device 206 comprises a data store 220 and implements a UC management and analysis engine 222. (Other components of the server computer device 206, such as memory and one or more processors, are not shown for ease of illustration.) The data store 220 stores data that relates to operation and use of the UC system, as will be further described below. The management and analysis engine 222 interacts with the data store 220. The data store 220 can store data and definitions that define elements to be displayed to an end user on a client computing device 202 or administrator computing device 208. For example, the data store 220 can store data that describes the frequency, quality, and other characteristics of communications (e.g., voice communications) that occur across an enterprise via a UC system. As another example, a definition defining a set of interface elements can be used to present a graphical user interface at administrator computing device 208 that can be used by a system administrator that is seeking to diagnose the cause of a reported problem in the UC system, as explained in detail below.

In the example shown in FIG. 2, the client computing device 202 includes output device(s) 210 and input device(s) 212 and executes a UC client engine 214. (Other components of the client computing device 202, such as memory and one or more processors, are not shown for ease of illustration.) In at least one embodiment, software corresponding to the UC client engine 214 is provided to the client computing device 202 in a cloud-based software distribution model. In a cloud-based model, the UC client engine 214 may be provided by an application server (not shown) or by some other computing device or system.

The UC client engine 214 is configured to process input and generate output related to UC services and content (e.g., services and content provided by the server 206). The UC client engine 214 also is configured to cause output device(s) 210 to provide output and to process input from input device(s) 212 related to UC services. For example, input device(s) 212 can be used to provide input (e.g., text input, video input, audio input, or other input) that can be used to participate in UC services (e.g., instant messages (IMs), voice calls, video calls), and output device(s) 210 (e.g., speakers, a display) can be used to provide output (e.g., graphics, text, video, audio) corresponding to UC services.

In the example shown in FIG. 2, the administrator computing device 208 includes output device(s) 230 and input device(s) 232 and executes a UC administrator engine 234. (Other components of the administrator computing device 208, such as memory and one or more processors, are not shown for ease of illustration.) In at least one embodiment, software corresponding to the UC administrator engine 234 is provided to the administrator computing device 208 in a cloud-based software distribution model. In a cloud-based model, the UC administrator engine 234 may be provided by an application server (not shown) or by some other computing device or system.

The UC administrator engine 234 is configured to receive, send, and process information relating to UC services. The UC administrator engine 234 is configured to cause output device(s) 230 to provide output and to process input from input device(s) 232 related to UC services. For example, input device(s) 232 can be used to provide input for administering or participating in UC services, and output device(s) 230 can be used to provide output corresponding to UC services.

The UC client engine 214 and/or the UC administrator engine 234 can be implemented as a custom desktop application or mobile application, such as an application that is specially configured for using or administering UC services. Alternatively, the UC client engine 214 and/or the UC administrator engine 234 can be implemented in whole or in part by an appropriately configured browser, such as the Internet Explorer® browser by Microsoft Corporation, the Firefox® browser by the Mozilla Foundation, and/or the like. Configuration of a browser may include browser plug-ins or other modules that facilitate instant messaging, recording and viewing video, or other functionality that relates to UC services.

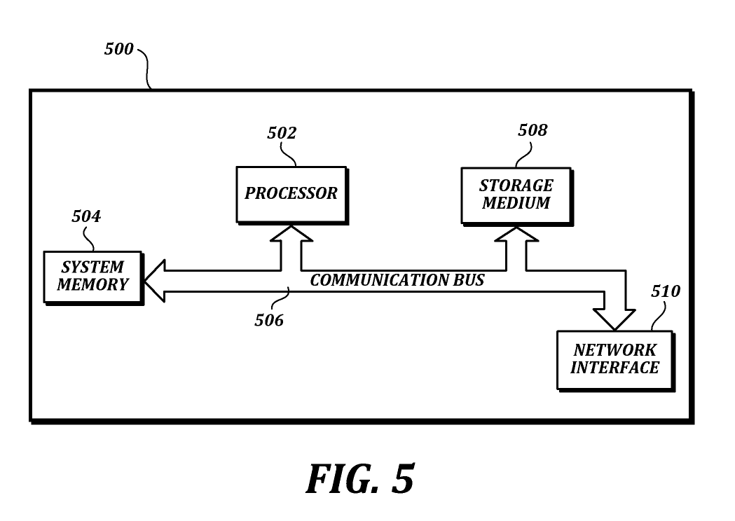

In any of the described examples, an “engine” may include computer program code configured to cause one or more computing device(s) to perform actions described herein as being associated with the engine. For example, a computing device can be specifically programmed to perform the actions by having installed therein a tangible computer-readable medium having computer-executable instructions stored thereon that, when executed by one or more processors of the computing device, cause the computing device to perform the actions. An exemplary computing device is described further below with reference to FIG. 5. The particular engines described herein are included for ease of discussion, but many alternatives are possible. For example, actions described herein as associated with two or more engines on multiple devices may be performed by a single engine. As another example, actions described herein as associated with a single engine may be performed by two or more engines on the same device or on multiple devices.

In any of the described examples, a “data store” contains data as described herein and may be hosted, for example, by a database management system (DBMS) to allow a high level of data throughput between the data store and other components of a described system. The DBMS may also allow the data store to be reliably backed up and to maintain a high level of availability. For example, a data store may be accessed by other system components via a network, such as a private network in the vicinity of the system, a secured transmission channel over the public Internet, a combination of private and public networks, and the like. Instead of or in addition to a DBMS, a data store may include structured data stored as files in a traditional file system. Data stores may reside on computing devices that are part of or separate from components of systems described herein. Separate data stores may be combined into a single data store, or a single data store may be split into two or more separate data stores.

Voice Quality Overview

Maintaining acceptable audio quality requires an understanding of UC system infrastructure and proper functioning of the network, communication devices, and other components. An administrator will often need to be able to quantifiably track overall voice quality in order to confirm improvements and identify areas of potential difficulty (or “hot spots”) that require further effort to resolve. There may be a hierarchy of issues, ranging from network issues (typically being both common and important to fix), to issues that are specific to local users (such as whether local users are using non-optimal devices), to issues that are specific to remote users, over which an administrator may have little control. Such issues may affect other forms of communication as well, such as video calls.

In order to isolate a grouping of calls with poor voice quality, it is important to have consistent and meaningful classification of calls. For example, wireless calls which have poor voice quality are important to group together to identify common patterns (e.g., whether the calls involve the same user) and to take appropriate action (e.g., educate the user to not use wireless, or upgrade the wireless infrastructure).

Additionally, some problems may have more impact on voice quality than others, even within the same call. For example, a user who is using a wireless connection and is roaming outside the user's usual network may be calling another user who is on the corporate network using a wired connection. In this case, the overall experience may be impacted by the first user's wireless connection. An analysis of the conditions at the two endpoints can be conducted to determine which endpoint is more likely to impact a call and highlight one or more items to consider addressing (e.g., by encouraging a user to switch from a wireless connection to a wired connection for the next call).

Classification of calls with certain general common characteristics may be helpful at some level for understanding voice quality issues. However, further classification may be needed for better understanding of a problem. The further classification may include any of several factors, including geography (users, infrastructure, etc.), time, specific site, etc. Regarding time, classification and analysis at different levels of time granularity (e.g., weekly, monthly, daily) may be used, and may allow for a corresponding ability to view trends over time (e.g., week-to-week, month-to-month, year-to-year). Not all classifications or geographies with poor audio quality will require the same level of attention. For example, a geography that is having 1 poor call out of 10 is likely worth investing more time in than one with 1 poor call out of 100.

The definition of a poor call can be provided by a UC platform, by an enterprise that uses the UC platform, or in some other way. The definition of a poor call may differ between platforms or enterprises, but it includes specific criteria for consistent classification of calls for the particular platform or enterprise.

In at least one embodiment, a poor call is defined as a call with one or more call quality metrics (e.g., degradation, latency, packet loss, jitter, or other metrics) that are outside a predefined value range. Metrics that can lead to a call being classified as poor in an illustrative UC platform are shown in Table 1, below, along with illustrative threshold values.

TABLE 1
Illustrative metrics and threshold values for poor calls.

| Metric | Threshold | Meaning |
|---|---|---|
| Degradation | >1.0 | Network Mean Opinion Score (MOS) |
| average | | degradation for call (reduction in Network |
| | | MOS due to jitter/packet loss). In this |
| | | context, the Network MOS does not |
| | | measure actual user opinion of particular |
| | | calls, but instead is an automatically |
| | | calculated score based on call |
| | | characteristics, such as jitter and packet |
| | | loss. |
| Latency | >500 ms | Round trip time for corresponding data |
| | | packets. Can result in unacceptable delay. |
| Packet Loss | >0.1 | Average rate of packet loss, where packet |
| Rate | (10%) | fails to reach destination-can result in |
| | | distorted/missing audio signal. |
| Average | >30 ms | Average delay between packet arrivals-can |
| Network Jitter | | result in distorted/missing audio signal. |
| Concealed | >0.07 | Average ratio of concealed samples to total |
| Samples Ratio | | samples, where concealed audio samples |
| (Average) | | are modified to smooth transitions |
| | | between packets in case of packet loss |
| | | or jitter-can result in distorted audio. |

The particular metrics used to classify a call as poor, as well as the threshold values for such metrics, can vary depending on implementation and may be adjustable, as well, based on specific requirements or preferences. The metrics used to classify a call as poor may be detected by a UC system itself, or by monitoring software deployed in combination with a UC system.

A threshold for an acceptable amount of poor calls also can be provided by a UC platform, by an enterprise, or in some other way. As an example, 2% may be set as a threshold percentage (or maximum acceptable percentage) of poor calls. Other lower or higher threshold percentages also may be used. Such thresholds may be set by default and may be modified if desired.

### II. Voice Quality Dashboard for Unified Communication System

In this section, various examples of features that may be included in a voice quality monitoring system in a communication system (e.g., a UC system) are described. Referring again to FIG. 2, the voice quality monitoring system may be implemented, for example, as part of the UC management and analysis engine 222 of server computing device 206, the UC administrator engine 234 of administrator computing device 208, or the UC client engine 214 of client computing device 202, or it may be distributed among multiple devices. The individual features described in this section may be implemented together, independently, or in various subsets, as may be appropriate for a particular implementation. Features described in this section may be implemented along with or independent of any of the features described in Section I, above.

In this section, techniques are described for identifying root causes of and resolving voice quality problems. Techniques described herein can be used to enable enterprises to easily and effectively discover prioritized and correct action, such as by sorting various categories of items (e.g., sites, client versions, etc.) to discover significant contributors to voice quality problems, prioritizing events and conditions, and presenting information at the right level of detail, such that appropriate remedial actions resulting from that information can be determined.

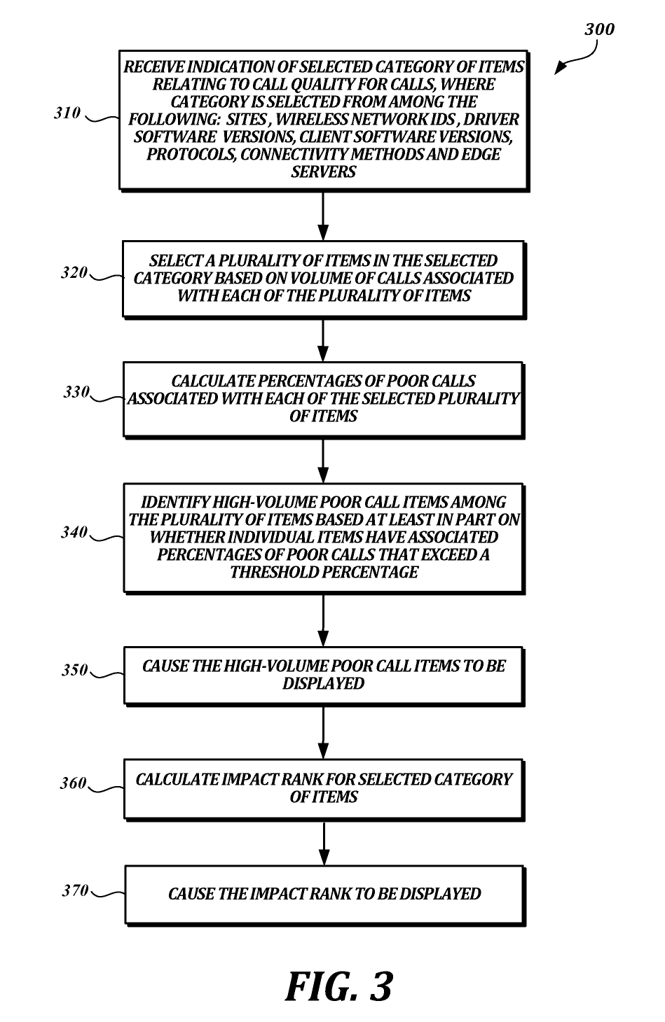

FIG. 3 is a flowchart of an illustrative process 300 for automatically identifying high-volume poor call items in selected categories of items relating to call quality, and calculating impact ranks for selected categories of items. The process 300 may be performed by a computing device that implements a voice quality monitoring system as described herein. In the example shown in FIG. 3, at step 310 the computing device receives an indication of a selected category of items relating to call quality for a plurality of calls. (The category may be selected by a user or administrator, e.g., via a voice quality dashboard, or automatically.) The category is selected from a group including sites, wireless network identifiers (e.g., basic service set IDs (BSSIDs)), driver software versions (e.g., WiFi drivers), client software versions, protocols (e.g., virtual private network (VPN), Transmission Control Protocol (TCP), User Datagram Protocol (UDP)), connectivity methods (e.g., direct, relay, HTTP), and edge servers used in the calls. At step 320, the computing device selects a plurality of items in the selected category based on volumes of calls associated with the plurality of items. For example, the computing device may select a top 50 of sites or other items by call volume. At step 330, the computing device calculates percentages of poor calls associated with the plurality of items. At step 340, the computing device identifies high-volume poor call items based at least in part on whether the items have associated percentages of poor calls that exceed a threshold percentage (e.g., 2% or some other percentage) of poor calls. At step 350, the computing device causes the high-volume poor call items to be displayed, either at the computing device that performs the process (e.g., in a voice quality dashboard), or at some other location.

In addition to sorting categories of items in this way and identifying high-volume poor call items, the computing device also may calculate impact ranks for categories of items. Referring again to FIG. 3, at step 360 the computing device calculates an impact rank for the selected category of items. For example, the impact rank may be based at least in part on distribution of poor calls among the selected category of items, with a lower rank being assigned if poor calls are generally evenly distributed, and a higher rank being assigned if particular items appear to be contributing disproportionately to the volume of poor calls. At step 370, the computing device causes the impact rank to be displayed, either at the computing device that performs the process (e.g., in a voice quality dashboard), or at some other location.

As will be understood in view of the examples described herein, many alternatives and variations to this process may be used in accordance with the disclosed subject matter.

### EXAMPLE

### Sorting Sites

In this example, an algorithm is provided for sorting, ranking, and/or prioritizing sites (e.g., to highlight them for further action or analysis) in a voice quality monitoring system. The result of the application of such an algorithm can be presented in a user interface, such as in the form of a site sorting page of a voice quality dashboard, or another user interface element suitable for viewing and/or interacting with a list of sites for voice quality monitoring. In at least one embodiment, the following factors (with illustrative calculations) are considered when ranking sites (see Table 2, below):

TABLE 2
Factors (with illustrative calculations) for ranking sites.

| Factor | Illustrative calculation |
|---|---|
| Poor Call % Above | Poor Calls/Calls > Threshold |
| Threshold | |
| Poor Call % | Poor Calls at the site/Total number of |
| Contribution to Total | Poor Calls across sites |
| Week Over Week | = (Poor % Last week-Avg (Poor Call % |
| change of Poor Call % | 5 prior weeks) ) − 0.8*STDEV (Poor |
| | Call % 5 prior weeks) If the value is |
| | positive, mark as a significant-change site. |

These illustrative factors can be used to highlight the sites that have a high probability to contribute to voice quality problems. In at least one embodiment, the following algorithm is used to prioritize sites for action or further analysis relating to voice quality:

1. Select Top 50 sites (or some other initial number of sites) by volume of calls. Alternatively, the initial number of sites can be selected based on some other metric, such as a metric that combines one or more of volume of calls, volume of poor calls, number of users at the site, etc. As another alternative, such as where only a small number of sites are to be analyzed, this step can be omitted.

2. Sort sites by percentage of poor calls. Mark all the sites above the poor call threshold (e.g., more than 2% of calls are poor calls).

3. Select a predetermined percentage of the initial number of sites with the highest percentage of poor calls as a contribution to the total (e.g., approximately 5%, or 3 out of the Top 50 (6%)). The sites that are above the threshold can be “bubbled up” and placed at the top of the list. (These sites can be considered “high volume poor calls” sites.)

4. Following the “high volume poor calls” sites, bubble up sites that are above the threshold and have been marked as significant-change sites. As noted above, significant-change sites can be determined based on a week-over-week change of percentage of poor calls (see Table 2, above), or on some other basis.

5. Following the significant-change sites, rank the rest of the sites that are above the threshold according to percentage of poor calls.

6. Additional sorting steps also can be performed, e.g., based on usage scenarios. For example, in an Internal Wireless to Server usage scenario, any sites where wireless quality (e.g., percentage of poor calls) is within 20% (or some other small percentage difference) of the Internal Wired to Server quality (Wireless quality<(Wired Quality+20%)) can be moved lower in the rankings, in order to account for the fact that wireless quality generally will be expected to be lower than wired quality.

### EXAMPLE

### Sorting Client Versions

In this example, an algorithm is provided for sorting, ranking, and/or prioritizing client versions (e.g., to highlight them for further action or analysis) in a voice quality monitoring system. The term “client versions” in this context refers to versions of communication software for various devices and configurations. Illustrative client versions include Skype® For Business client versions, which may include, for example, separate client versions for laptop or desktop computing devices, tablet computing devices, or smart phones running different operating systems; client versions for meeting room systems (such as those provided by SMART Technologies ULC of Calgary, Alberta, Canada); and client versions for internet protocol (IP) phones (such as those provided by Polycom, Inc., of San Jose, Calif.).

Detection and analysis of client versions can be important, for example, for determining whether particular client versions may be causing problems such as poor call quality. In this example, similar to sorting of sites, sorting of client versions first finds client versions that carry a majority of volume of calls, and then considers percentage of poor calls. The result of the application of such an algorithm can be presented in a user interface, such as in the form of a client version sorting page of a voice quality dashboard, or another user interface element suitable for viewing and/or interacting with a list of client versions.

In at least one embodiment, the following algorithm is used to prioritize client versions for action or further analysis relating to voice quality.

1. Select Top 50 client versions (or other some initial number of client versions) by volume of calls. Alternatively, the initial number of client versions can be selected based on some other metric, such as a metric that combines one or more of volume of calls, volume of poor calls, number of users, etc. As another alternative, such as where only a small number of client versions are to be analyzed, this step can be omitted.

2. Sort client versions by percentage of poor calls. Mark all the client versions above the poor call threshold (e.g., more than 2% of calls are poor calls).

3. Select a predetermined percentage of the initial number of client versions with the highest percentage of poor calls as a contribution to the total (e.g., approximately 10% (or 5 out of the Top 50)). The client versions that are above the threshold can be “bubbled up” and placed at the top of the list. (These client versions can be considered “high volume poor calls” client versions.)

4. Following the “high volume poor calls” client versions, bubble up client versions that are above the threshold and have been marked as significant-change client versions. Significant-change client versions can be determined based on a week-over-week change of percentage of poor calls (see Table 2, above), or on some other basis.

5. Following the significant-change client versions, rank the rest of the client versions that are above the threshold according to percentage of poor calls.

6. Additional sorting steps also can be performed to account for factors other than client version that may be affecting voice quality. As an example, any client versions that do not follow an overall client version trend across the enterprise (e.g., within 20% of the overall percentage of poor calls for other client versions) can be moved lower in the rankings.

### EXAMPLE

### Sorting BSSIDs, WiFi Drivers

In this example, sorting, ranking, and/or prioritizing BSSIDs (basic service set IDs) and WiFi drivers (e.g., to highlight them for further action or analysis) in a voice quality monitoring system is described. An algorithm similar to the algorithms described above for sorting sites and client versions can be used for this purpose. The result of the application of such an algorithm can be presented in a user interface, such as in the form of a BSSID or WiFi driver sorting page of a voice quality dashboard, or another user interface element suitable for viewing and/or interacting with a list of BSSIDs or WiFi drivers.

A BSSID is an identifier for a wireless local area network (LAN). An enterprise may have hundreds or even thousands of BSSIDs, and some of those may be associated with poor communication quality. Given a potentially large number of BSSIDs, it becomes very difficult for an enterprise to prioritize and determine which BSSIDs are problematic or which seem to correlate with poor user experiences. By automatically sorting BSSIDs according to the techniques described herein, the automatic analysis subsystem can allow an enterprise to follow up on and resolve the most impactful BSSIDs and users that are associated with those BSSIDs. An enterprise also may have many different WiFi drivers, with different versions for different computing devices within the enterprise. By automatically sorting WiFi drivers according to the techniques described herein, the automatic analysis subsystem can allow an enterprise to follow up on and resolve the most impactful WiFi drivers and users that are associated with these WiFi drivers.

### EXAMPLE

### Sorting Users

In this example, an algorithm is provided for sorting, ranking, and/or prioritizing top users (e.g., to highlight them for further action or analysis) in a voice quality monitoring system. The algorithm for top users may be less detailed than the algorithms described above for sorting sites and client versions, and may involve ranking top users (e.g., the top 50 or some other number of users) based on the number of poor calls for those users. For example, sorting users may proceed as follows, either for users across an enterprise, by site, or on some other basis:

1. Select Top 50 users (or some other initial number of users) by volume of calls.

2. Sort the selected users by percentage of poor calls. Mark all the users above the poor call threshold (e.g., more than 2% of calls are poor calls).

The result of the application of such an algorithm can be presented in a user interface, such as in the form of a user sorting page of a voice quality dashboard, or another user interface element suitable for viewing and/or interacting with a list of users.

### EXAMPLE

### Sorting Network Categories

In this example, an algorithm is provided for sorting, ranking, and/or prioritizing networks (e.g., to highlight them for further action or analysis) in a voice quality monitoring system. The result of the application of such an algorithm can be presented in a user interface, such as in the form of pages of a voice quality dashboard (or other user interface elements). The pages may include a protocol page (including virtual private network (VPN)) showing which protocol has been used, a connectivity page with ICE (Interactive Connectivity Establishment) values (e.g., Direct, Relay, HTTP, Failed), and an edge servers page.

In this example, the protocol may include any of the following list of values: VPN, TCP (non-VPN, or unknown VPN), UDP (non-VPN, or unknown VPN), or Other (a category of calls where it is not clear what protocol is used).

The algorithm helps identify how many calls were conducted using particular connectivity methods (e.g., Direct, Relay, HTTP). This information can then be used to identify whether suboptimal connectivity methods are being used. For example, in certain cases direct connectivity is preferred over a relay connection or an HTTP connection. If a relay connection is being used in such a case, a configuration issue on a server may need to be corrected.

The thresholds and the sorting are scenario-related. For example, for Internal to Server scenarios, VPN can be marked as high priority (e.g., color-coded red in a user interface) if any number of calls fall into this category. TCP can be marked as high priority if percentage of poor calls is above a scenario threshold, and otherwise as medium priority. UDP/Other can be marked as lower than high priority (e.g., medium or low priority). Regarding connectivity, Relay/HTTP/Failed can be marked as high priority if the percentage of poor calls is above the scenario threshold. Direct can be marked as lower than high priority (e.g., medium or low priority). Edge servers may be not relevant in this scenario, and the edge servers page can be omitted from the displayed results.

As another example, in External to Server scenarios, VPN can be marked as high priority (e.g., color-coded red) if any number of calls fall into this category. TCP can be marked as high priority if percentage of poor calls is above a scenario threshold, and otherwise as medium priority. UDP/Other can be marked as lower than high priority (e.g., medium or low priority). Regarding connectivity, HTTP/Failed can be marked as high priority if the percentage of poor calls is above the scenario threshold. Relay/Direct can be marked as lower than high priority (e.g., medium or low priority). The edge servers page may include a list of edge servers, which may be ranked as high priority if the percentage of poor calls is above the scenario threshold.

### EXAMPLE

### Sorting Categories in Preview Pane/Calculating Impact Ranks

In this example, an algorithm is provided for calculating impact ranks for different categories (e.g., sites, client versions, etc.) within different usage scenarios in a voice quality monitoring system. The result of the application of such an algorithm can be presented in a user interface, such as in the form of a preview pane of a voice quality dashboard, or another user interface element suitable for viewing and/or interacting with categories within different usage scenarios.

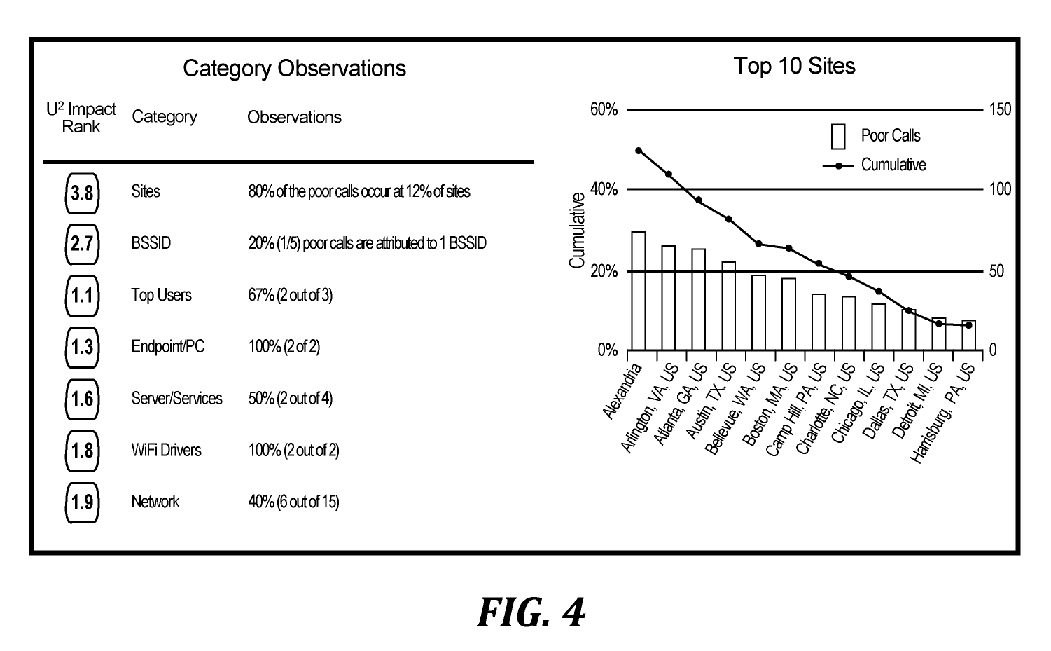

FIG. 4 is a screen shot of a user interface for displaying poor call information, including impact ranks and selected high-volume poor call items, in a voice quality dashboard of a voice quality monitoring system. In the example shown in FIG. 3, impact ranks and observations are provided in a preview pane for the following categories: Sites (3.8 impact rank), BSSID (2.7 impact rank), Top Users (1.1 impact rank), Endpoint/PC (1.3 impact rank), Server/Services (1.6 impact rank), WiFi Drivers (1.8 impact rank), and Network (1.9 impact rank). The preview pane may be provided in user interface along with other elements, such as the Top 10 Sites graph shown in FIG. 4, which graphs poor calls for individual sites and cumulative percentages of poor calls.

In at least one embodiment, the following approaches are used to calculate impact ranks (e.g., from 1 (lowest) to 5 (highest)) for categories within illustrative usage scenarios (see Table 3, below). Although illustrative calculations are shown, other heuristics also can be used to calculate impact ranks according to these approaches.

TABLE 3
Impact Rank Calculations by Scenario/Category

| Scenario | Category | Impact Rank |
|---|---|---|
| Internal | Sites/ | Rank 1: Poor Call % is evenly distributed across |
| Wireless | Subnets | 80% of top sites by volume. |
| to Server | | Rank 5: Top 10% of sites cause 80% of poor calls |
| or Internal | | and are over Poor Call % threshold (e.g., 2%). |
| Wired to | | Consider overall calls, including calls that are |
| Server | | not mapped to a particular site and may be |
| | | associated with a generic “Unknown” site. |
| | | Wired call quality (Poor Call %) is not above |
| | | the Poor Call % threshold for these sites. |
| | | Illustrative impact rank calculation: |
| | | Sort sites by volume of poor calls-select sites |
| | | that add up to 80% of the poor call volume |
| | | (excluding long tail-can exclude sites that |
| | | only add small numbers of poor calls if they |
| | | would be otherwise needed to get up to the |
| | | 80% figure). |
| | | Mark the selected sites that are above the |
| | | Poor Call % threshold. |
| | | Exclude the sites that have a high wired |
| | | Poor Call %. |
| | | Rank = 5 − ((number of such sites)/ |
| | | all sites * (PSV %)) *5 |
| | | (where PSV % = number of poor calls in |
| | | such sites and above the threshold/80% of |
| | | poor calls) |
| | BSSID | Rank 1: Poor Call % is evenly distributed across |
| | (does not | BSSIDs that are at least ¾ of the median by |
| | apply to | volume (excluding long tail related to the BSSIDs |
| | Wired | that fall outside of the range of ¾ |
| | calls) | from the median). The approach here assumes |
| | | that there is a large number of BSSIDs and |
| | | could eliminate BSSIDs with low volume of calls. |
| | | Rank 5: Top 10% BSSIDs by volume are above |
| | | the Poor Call % threshold (e.g., 2%) and wired |
| | | quality on the same subnets is good and is of |
| | | sufficient volume to indicate that wired |
| | | infrastructure is not itself the primary cause |
| | | of the poor calls. |
| | | Illustrative impact rank calculation: |
| | | Sort BSSIDs by volume-select only BSSIDs |
| | | that are no lower than ¾ of median call volume. |
| | | Compute number of selected BSSIDs with a |
| | | Poor Call % that is 2x above the Poor Call % |
| | | threshold. |
| | | Rank = 5 − ((number of such BSSIDs)/ |
| | | all BSSIDs) *10. |
| | Client | Rank 1: Poor Call % is evenly distributed across |
| | Versions | 80% of top versions by volume. |
| | | Rank 5: Top 10% of versions cause 80% of poor |
| | | calls and are over the Poor Call % threshold |
| | | (e.g., 2%) and show a consistent overall trend |
| | | across call scenarios (e.g., Wired/Wireless to |
| | | Server, Endpoint to Endpoint, etc.), indicating |
| | | that the client version is causing the problem, |
| | | rather than a particular scenario. |
| | | Illustrative impact rank calculation: |
| | | See Sites calculation. |
| | WiFi | Rank 1: Poor Call % is evenly distributed across |
| | Drivers | 80% of top WiFi Drivers by volume. |
| | (does not | Rank 5: Top 10% of drivers cause 80% of poor |
| | apply to | calls and are over the Poor Call % threshold |
| | Wired | (e.g., 2%), show a consistent overall trend across |
| | calls) | call scenarios, and are of lower quality (i.e., higher |
| | | Poor Call %) than a Wired scenario. BSSID |
| | | quality and Site quality ranked low. |
| | | Illustrative impact rank calculation: |
| | | Same as sites calculation given BSSID and |
| | | Site quality ranked low, otherwise subtract 2. |
| External | External | Rank 1: TCP, VPN, and Edge category Poor Call |
| Wireless | Access | % are each under ⅓ of the Poor Call % |
| to Server | Network | Threshold. |
| or External | | Rank 5: Poor Call % of TCP or VPN above 10% |
| Wired to | | of calls, or Edge Poor Call % is 2x above Poor |
| Server | | Call % threshold. |
| | | Illustrative impact rank calculation: |
| | | Rank = MAX (5 − ((TCP)/all calls ) * 10, |
| | | 5* (fraction of Edge poor calls above threshold) |
| | | Note: TCP traffic is expected to be a small |
| | | portion of overall traffic. Therefore, the |
| | | illustrative calculation gives higher weight to |
| | | cases when TCP traffic grows. The weights can |
| | | be adjusted as needed for particular situations. |
| | Client | Same as above. |
| | Versions | |
| | WiFi | Same as above. |
| | Drivers | |
| | Users | Same as above. |
| Server to | Network | Same as above. |
| Server | | |
| | Server to | Rank 1: Poor Call % is below threshold |
| | Server | (e.g., 2%). |
| | | Rank 5: Poor Call % is 2x above |
| | | threshold (e.g., 4% if threshold is 2%). |
| | | Illustrative impact rank calculation: |
| | | Rank = 10 * (fraction of poor calls above |
| | | threshold) For example, 10 * (0.4 − 0.2) = 5, |
| | | where Poor Call % is 4% and threshold is 2%. |
| | | Note: up to maximum rank of 5. |
| | Server Site | Rank 1: Poor Call % is below threshold |
| | to Server | (e.g., 2%). |
| | Site | Rank 5: Poor Call % is 2x above threshold |
| | | (e.g., 4% if threshold is 2%). |
| | | Illustrative impact rank calculation: |
| | | See Server to Server calculation. |

It should be understood that the examples provided above are not exhaustive and additional impact rank calculations can be performed on a similar basis these scenarios and categories, or for other scenarios (such as endpoint-to-endpoint) or categories within scenarios (such as internal wired to internal wired).

### EXAMPLE

### Weighting of Poor Calls

In examples described herein, poor calls can be weighted in different ways. In one possible approach, calls classified as poor are weighted evenly regardless of other characteristics of the calls. In another possible approach, calls classified as poor may be weighted differently depending on other characteristics of the calls. For example, to account for call duration in ranking and sorting, a short call classified as poor (e.g., less than one minute, or some other length of time) may be given less weight (e.g., half, or 0.5) than a longer poor call. As another example, to account for how calls are terminated in ranking and sorting, return codes, diagnostic codes, or other information may be used to indicate whether a call was dropped due to poor quality. Such calls may be given greater weight than poor calls that were terminated for other reasons.

### EXAMPLE

### Drill-Down and Modification

In examples described herein, a user may interact with a sorting page of a voice quality dashboard, or another user interface element suitable for viewing and/or interacting with a list of items to “drill down” for additional details on the items or allow for modifications of the items. For example, a network engineer may be permitted to modify a list of top sites or client versions with poor calls for exclusion or marking of the sites with known bad devices or problematic client versions.

### III. Operating Environment

Unless otherwise specified in the context of specific examples, described techniques and tools may be implemented by any suitable computing devices, including, but not limited to, laptop computers, desktop computers, smart phones, tablet computers, and/or the like.

Some of the functionality described herein may be implemented in the context of a client-server relationship. In this context, server devices may include suitable computing devices configured to provide information and/or services described herein. Server devices may include any suitable computing devices, such as dedicated server devices. Server functionality provided by server devices may, in some cases, be provided by software (e.g., virtualized computing instances or application objects) executing on a computing device that is not a dedicated server device. The term “client” can be used to refer to a computing device that obtains information and/or accesses services provided by a server over a communication link. However, the designation of a particular device as a client device does not necessarily require the presence of a server. At various times, a single device may act as a server, a client, or both a server and a client, depending on context and configuration. Actual physical locations of clients and servers are not necessarily important, but the locations can be described as “local” for a client and “remote” for a server to illustrate a common usage scenario in which a client receives information provided by a server at a remote location.

FIG. 5 is a block diagram that illustrates aspects of an illustrative computing device 500 appropriate for use in accordance with embodiments of the present disclosure. The description below is applicable to servers, personal computers, mobile phones, smart phones, tablet computers, embedded computing devices, and other currently available or yet-to-be-developed devices that may be used in accordance with embodiments of the present disclosure.

In its most basic configuration, the computing device 500 includes at least one processor 502 and a system memory 504 connected by a communication bus 506. Depending on the exact configuration and type of device, the system memory 504 may be volatile or nonvolatile memory, such as read only memory (“ROM”), random access memory (“RAM”), EEPROM, flash memory, or other memory technology. Those of ordinary skill in the art and others will recognize that system memory 504 typically stores data and/or program modules that are immediately accessible to and/or currently being operated on by the processor 502. In this regard, the processor 502 may serve as a computational center of the computing device 500 by supporting the execution of instructions.

As further illustrated in FIG. 5, the computing device 500 may include a network interface 510 comprising one or more components for communicating with other devices over a network. Embodiments of the present disclosure may access basic services that utilize the network interface 510 to perform communications using common network protocols. The network interface 510 may also include a wireless network interface configured to communicate via one or more wireless communication protocols, such as WiFi, 2G, 3G, 4G, LTE, WiMAX, Bluetooth, and/or the like.

In the illustrative embodiment depicted in FIG. 5, the computing device 500 also includes a storage medium 508. However, services may be accessed using a computing device that does not include means for persisting data to a local storage medium. Therefore, the storage medium 508 depicted in FIG. 5 is optional. In any event, the storage medium 508 may be volatile or nonvolatile, removable or nonremovable, implemented using any technology capable of storing information such as, but not limited to, a hard drive, solid state drive, CD-ROM, DVD, or other disk storage, magnetic tape, magnetic disk storage, and/or the like.

As used herein, the term “computer-readable medium” includes volatile and nonvolatile and removable and non-removable media implemented in any method or technology capable of storing information, such as computer-readable instructions, data structures, program modules, or other data. In this regard, the system memory 504 and storage medium 508 depicted in FIG. 5 are examples of computer-readable media.

For ease of illustration and because it is not important for an understanding of the claimed subject matter, FIG. 5 does not show some of the typical components of many computing devices. In this regard, the computing device 500 may include input devices, such as a keyboard, keypad, mouse, trackball, microphone, video camera, touchpad, touchscreen, electronic pen, stylus, and/or the like. Such input devices may be coupled to the computing device 500 by wired or wireless connections including RF, infrared, serial, parallel, Bluetooth, USB, or other suitable connection protocols using wireless or physical connections.

In any of the described examples, data can be captured by input devices and transmitted or stored for future processing. The processing may include encoding data streams, which can be subsequently decoded for presentation by output devices. Media data can be captured by multimedia input devices and stored by saving media data streams as files on a computer-readable storage medium (e.g., in memory or persistent storage on a client device, server, administrator device, or some other device). Input devices can be separate from and communicatively coupled to computing device 500 (e.g., a client device), or can be integral components of the computing device 500. In some embodiments, multiple input devices may be combined into a single, multifunction input device (e.g., a video camera with an integrated microphone). Any suitable input device either currently known or developed in the future may be used with systems described herein.

The computing device 500 may also include output devices such as a display, speakers, printer, etc. The output devices may include video output devices such as a display or touchscreen. The output devices also may include audio output devices such as external speakers or earphones. The output devices can be separate from and communicatively coupled to the computing device 500, or can be integral components of the computing device 500. In some embodiments, multiple output devices may be combined into a single device (e.g., a display with built-in speakers). Further, some devices (e.g., touchscreens) may include both input and output functionality integrated into the same input/output device. Any suitable output device either currently known or developed in the future may be used with described systems.

In general, functionality of computing devices described herein may be implemented in computing logic embodied in hardware or software instructions, which can be written in a programming language, such as C, C++, COBOL, JAVA™, PHP, Perl, HTML, CSS, JavaScript, VBScript, ASPX, Microsoft .NET™ languages such as C#, and/or the like. Computing logic may be compiled into executable programs or written in interpreted programming languages. Generally, functionality described herein can be implemented as logic modules that can be duplicated to provide greater processing capability, merged with other modules, or divided into sub-modules. The computing logic can be stored in any type of computer-readable medium (e.g., a non-transitory medium such as a memory or storage medium) or computer storage device and be stored on and executed by one or more general-purpose or special-purpose processors, thus creating a special-purpose computing device configured to provide functionality described herein.

### IV. Extensions and Alternatives

Many alternatives to the described systems are possible. For example, although illustrative techniques are described herein with reference to voice quality for audio calls, such techniques can be adapted for other identifying and resolving issues relating to other features of UC services, such as audio conferences, video conferences, federated activity, PSTN usage in conferencing, and mobile usage. As another example, although particular sorting and ranking techniques are described, it should be understood that the specific techniques described may vary relative to the described examples, such as by omitting sorting criteria where such logic depends on a higher volume of data to meaningfully identify trends, and that volume of data is not currently available. As another example, sorting of pages other than those described herein can be performed and may follow the logic of other categories pages described herein.

Many alternatives to the systems and devices described herein are possible. For example, individual modules or subsystems can be separated into additional modules or subsystems or combined into fewer modules or subsystems. As another example, modules or subsystems can be omitted or supplemented with other modules or subsystems. As another example, functions that are indicated as being performed by a particular device, module, or subsystem may instead be performed by one or more other devices, modules, or subsystems. Although some examples in the present disclosure include descriptions of devices comprising specific hardware components in specific arrangements, techniques and tools described herein can be modified to accommodate different hardware components, combinations, or arrangements. Further, although some examples in the present disclosure include descriptions of specific usage scenarios, techniques and tools described herein can be modified to accommodate different usage scenarios. Functionality that is described as being implemented in software can instead be implemented in hardware, or vice versa.

Many alternatives to the techniques described herein are possible. For example, processing stages in the various techniques can be separated into additional stages or combined into fewer stages. As another example, processing stages in the various techniques can be omitted or supplemented with other techniques or processing stages. As another example, processing stages that are described as occurring in a particular order can instead occur in a different order. As another example, processing stages that are described as being performed in a series of steps may instead be handled in a parallel fashion, with multiple modules or software processes concurrently handling one or more of the illustrated processing stages. As another example, processing stages that are indicated as being performed by a particular device or module may instead be performed by one or more other devices or modules.

Many alternatives to the user interfaces described herein are possible. In practice, the user interfaces described herein may be implemented as separate user interfaces or as different states of the same user interface, and the different states can be presented in response to different events, e.g., user input events. The elements shown in the user interfaces can be modified, supplemented, or replaced with other elements in various possible implementations.

While illustrative embodiments have been illustrated and described, it will be appreciated that various changes can be made therein without departing from the spirit and scope of the claimed subject matter.

The embodiments of the invention in which an exclusive property or privilege is claimed are defined as follows:

1. A computer system comprising at least one processor and computer-readable media having instructions stored thereon that, when executed by the at least one processor, cause the computer system to:
receive an indication of a selected category of items relating to call quality for a plurality of voice calls, wherein the category of items is selected from the group consisting of: sites used in the voice calls, wireless network identifiers used in the voice calls, driver software versions used in the voice calls, client software versions used in the voice calls, protocols used in the voice calls, connectivity methods used in the voice calls, and edge servers used in the voice calls;
select a plurality of items in the selected category based on volumes of calls associated with the plurality of items;
calculate percentages of poor calls associated with the selected plurality of items;
identify high-volume poor call items among the plurality of items based at least in part on whether individual items have associated percentages of poor calls that exceed a threshold percentage; and
cause the high volume poor call items to be displayed.

2. The computer system of claim 1, wherein the instructions further cause the computer system to:
calculate an impact rank for the selected category of items further based at least in part on distribution of poor calls among the selected plurality of items; and
cause the impact rank for the selected category of items to displayed.

3. The computer system of claim 2, wherein the impact rank for the selected category of items is further based on call scenario.

4. The computer system of claim 1, wherein the selected category of items is sites used in the calls.

5. The computer system of claim 1, wherein the selected category of items is wireless network identifiers used in the calls, and wherein the wireless network identifiers are basic service set IDs.

6. The computer system of claim 1, wherein the selected category of items is driver software versions used in the calls, and wherein the driver software versions are WiFi driver versions.

7. The computer system of claim 1, wherein the selected category of items is client software versions used in the calls, and wherein the client software versions are selected from the group consisting of: client software versions for desktop or laptop computing devices; client software versions for meeting room systems, and client software versions for internet protocol phones.

8. The computer system of claim 1, wherein the selected category of items is protocols used in the calls, and wherein the protocols used in the calls are selected from the group consisting of virtual private network (VPN), Transmission Control Protocol (TCP), and User Datagram Protocol (UDP).

9. The computer system of claim 1, wherein the selected category of items is connectivity methods used in the calls, and wherein the connectivity methods used in the calls are selected from the group consisting of: direct, relay, and HTTP.

10. A computer-implemented method comprising, by a computer system comprising at least one processor:
receiving an indication of a selected category of items relating to call quality for a plurality of calls, wherein the category of items is selected from the group consisting of:
sites used in the calls, wireless network identifiers used in the calls, driver software versions used in the calls, client software versions used in the calls, protocols used in the calls, connectivity methods used in the calls, and edge servers used in the calls;
selecting a plurality of items in the selected category based on volumes of calls associated with the plurality of items;
calculating percentages of poor calls associated with the selected plurality of items;
identifying high-volume poor call items among the plurality of items based at least in part on whether individual items have associated percentages of poor calls that exceed a threshold percentage; and
causing the high volume poor call items to be displayed.

11. The method of claim 10, further comprising:
calculating an impact rank for the selected category of items further based at least in part on distribution of poor calls among the selected plurality of items; and
causing the impact rank for the selected category of items to displayed.

12. The method of claim 11, wherein the impact rank for the selected category of items is further based on call scenario.

13. The method of claim 10, wherein the selected category of items is sites used in the calls.

14. The method of claim 10, wherein the selected category of items is wireless network identifiers used in the calls, and wherein the wireless network identifiers are basic service set IDs.

15. The method of claim 10, wherein the selected category of items is driver software versions used in the calls, and wherein the driver software versions are WiFi driver versions.

16. The method of claim 10, wherein the selected category of items is client software versions used in the calls, and wherein the client software versions are selected from the group consisting of: client software versions for desktop or laptop computing devices; client software versions for meeting room systems, and client software versions for internet protocol phones.

17. The method of claim 10, wherein the selected category of items is protocols used in the calls, and wherein the protocols used in the calls are selected from the group consisting of virtual private network (VPN), Transmission Control Protocol (TCP), and User Datagram Protocol (UDP).

18. The method of claim 10, wherein the selected category of items is connectivity methods used in the calls, and wherein the connectivity methods used in the calls are selected from the group consisting of: direct, relay, and HTTP.

19. The method of claim 10, wherein the calls are voice calls.

20. A non-transitory computer-readable medium having instructions stored thereon that, when executed by at least one processor, cause a computer system to:
receive an indication of a selected category of items relating to call quality for a plurality of voice calls, wherein the category of items is selected from the group consisting of: sites used in the voice calls, wireless network identifiers used in the calls, driver software versions used in the voice calls, client software versions used in the voice calls, protocols used in the voice calls, connectivity methods used in the voice calls, and edge servers used in the voice calls;
select a plurality of items in the selected category based on volumes of calls associated with the plurality of items;
calculate percentages of poor calls associated with the selected plurality of items;
identify high-volume poor call items among the plurality of items based at least in part on whether individual items have associated percentages of poor calls that exceed a threshold percentage; and
cause the high volume poor call items to be displayed.
